(19) United States
(12) Patent Application Publication
(10) Pub. No.: US 2006/0067707 A1
(43) Pub. Date: Mar. 30, 2006

(54) System and method for increasing data communication bandwidth in a light communication system

(76) Inventors: Selvan Maniam, Pulau Pinang (MY); Kean Loo Keh, Penang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/954,925

(22) Filed: Sep. 30, 2004

(51) Int. Cl. H04B 10/04

(52) U.S. Cl. 398/183

(57) ABSTRACT

In one embodiment, color sensors allow multiple data transfer channels to occur between a light source and a light detector. Light of differing wavelengths can be detected simultaneously and the modulated data on each wavelength can be independently and simultaneously processed. If desired, data from a selected wavelength can be delivered to an end-user. In another embodiment, different colors can be used for different directions of communication thereby allowing for simultaneous bi-directional communication.

### TECHNICAL FIELD

This invention relates to visual light communication systems and more particularly to systems and methods for increasing data communication bandwidth.

### BACKGROUND OF THE INVENTION

The use of infrared (IR) signals has become commonplace for transmitting line of sight information from one place to another. Such IR signaling is employed, for example, in hand-held controls used for turning television sets and other electronic devices on-off and for changing channels, volume control, etc. These devices are specially designed for communications there between and such communications, since they are in the IR band, are not meant for general purpose communications.

Light in the visual range is now being investigated for communication purposes. Such systems, known as visual light communication (VLC) systems, use commonly available light sources, such as LED and LCD displays for communication purposes. Thus, a device that serves the purpose of displaying information (or even simply providing illumination) can also be simultaneously used to transmit information to one or more light receptacles. In a VLC system data is modulated onto the visible light coming from the light source and any detector (demodulator) that is in the path of the visible light can receive that data.

As with most communication systems, the bandwidth soon fills thus limiting the data transfer rate between the light source and the light detector. If VLC systems are to become a source for data transfer to and from mobile devices, such as PDA's, computers, and the like, it is important that the data transfer bandwidth be as high as possible.

### BRIEF SUMMARY OF THE INVENTION

In one embodiment, color sensors allow multiple data transfer channels to occur between a light source and a light detector. Light of differing wavelengths can be detected simultaneously and the modulated data on each wavelength delivered can be independently and simultaneously processed, and, if desired, selectively to an end-user.

In another embodiment, different colors can be used for different directions of communication thereby allowing for simultaneous bi-directional communication.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A, 1B, and IC show various embodiments of one aspect of the inventive concept;

FIG. 2 shows one embodiment of the system for one-way multi-channel communication; and

FIG. 3 shows one embodiment of the system for bi-directional multi-channel operation.

### DETAILED DESCRIPTION OF THE INVENTION

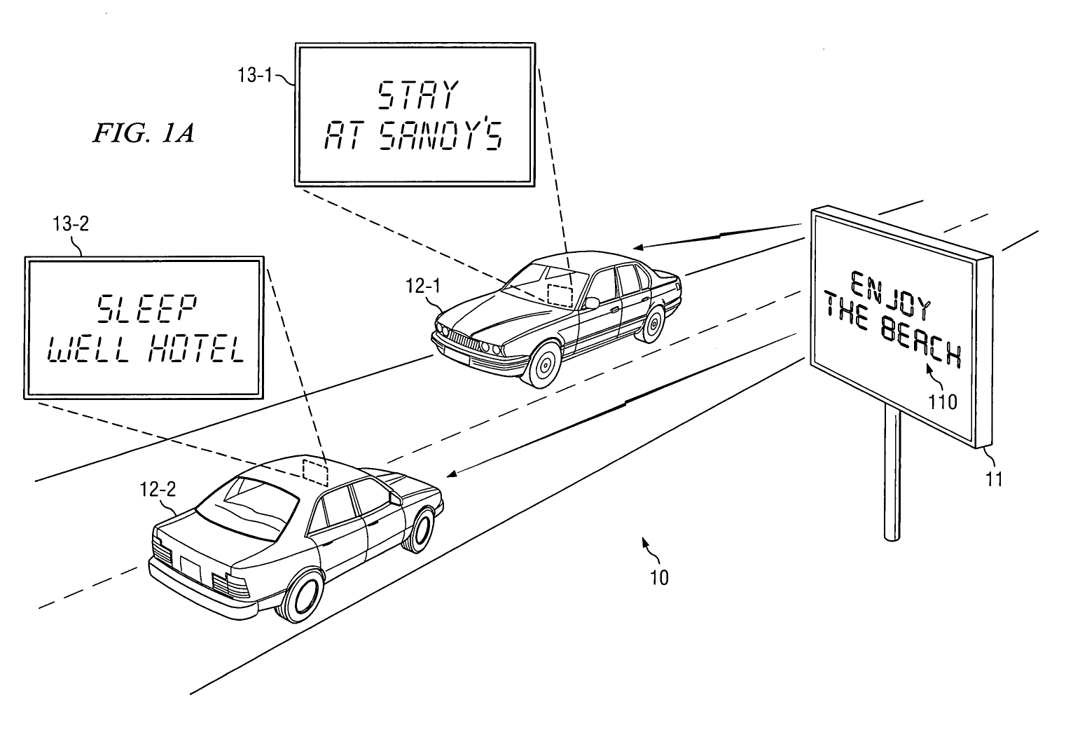

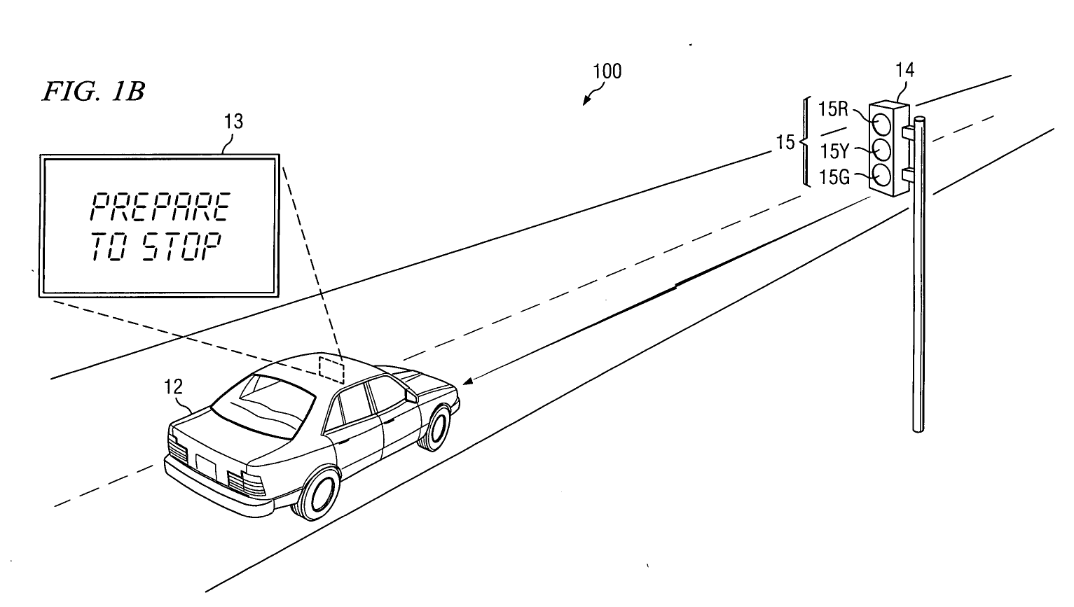

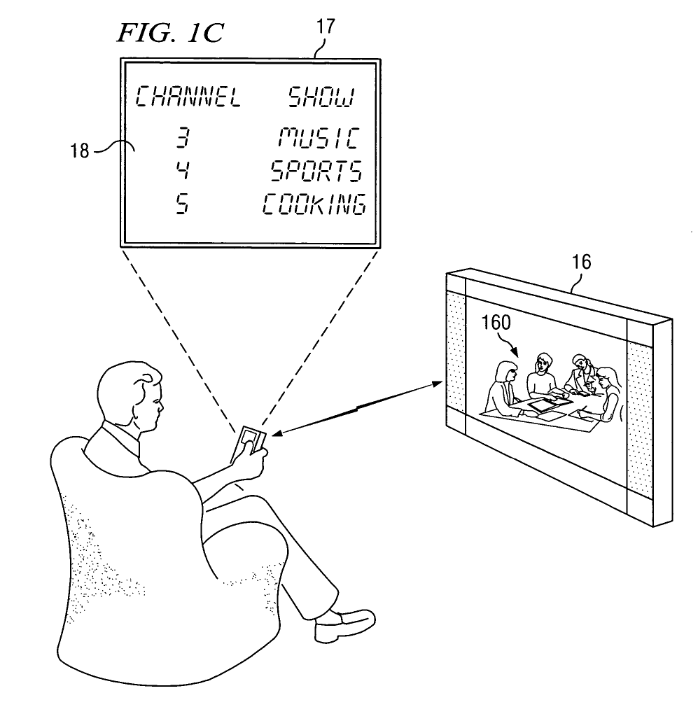

FIG. 1A shows system 10 in which electronic sign 11 displays information 110 to the viewing public. In this context, I will call such displayed information communally broadcast information. The light source(s) for electronic sign 11, as will be discussed, can be modulated over various channels so that a specific message can be delivered over one channel to car 12-1 and a different message delivered to car 12-2. A message in car 12-1 can be displayed, via display 13-1 with a first message while display 13-2 in car 12-2 could have a separate message. With each message being delivered using a different light color from light source 11 which forms a visual light communication system (VLC). It should be noted that the data, while displayed as slogan or information on a screen, in the example, could also be, for example, information for controlling the car or any other data desired to be transmitted. Also note that the display in a particular car could be “tuned” to receive different channels.

FIG. 1B shows one example of system 100 using the red (15R), yellow (15Y), and green (15G) lights of traffic signal 14, in which lights 15 are used in the conventional matter to control the flow of traffic. These lights, for example, could be comprised of a plurality of individual LEDs such that red light 15R, yellow light 15Y, and green light 15G would each have perhaps 100 light emitting diodes (LEDs) similarly for yellow light 15Y and for green light 15G. If it is desired to communicate multi-channel information, one or more of the cluster of LEDs that comprise light 15R can be modulated with data. This modulated light is demodulated by mobile device 12-1, and the data displayed within the module device. Note that in FIG. 1B all three light sources (15R, 15Y, and 15G) can be utilized to provide a three-channel system.

FIG. 1C shows still another embodiment using a television set (TV) 16 as a light source. TV 16 has displayed thereon image 160 which is the communal picture available to any viewer TV 16. Each pixel of TV 16 is made up from these different color light sources red, green, and blue. The liquid crystal displays (LCDs) or other light sources within TV 16 can be individually modulated so that a remote display, such as display 17, can receive information modulated on the visible light from TV 16. For example, TV 16 could send three or more different channels of information, each channel serving a different purpose, with each channel using a separate color (frequency). This modulated data could be used for controlling other devices, or for displaying information, etc., all under control of TV 16. Note that the modulation can be locally controlled or could be controlled via the signals provided to TV 16 from a remote source. Thus, a remote source can, in addition to providing the visual entertainment on TV 16, provide control for various different electronic equipment, or various messages, in proximity to TV 16.

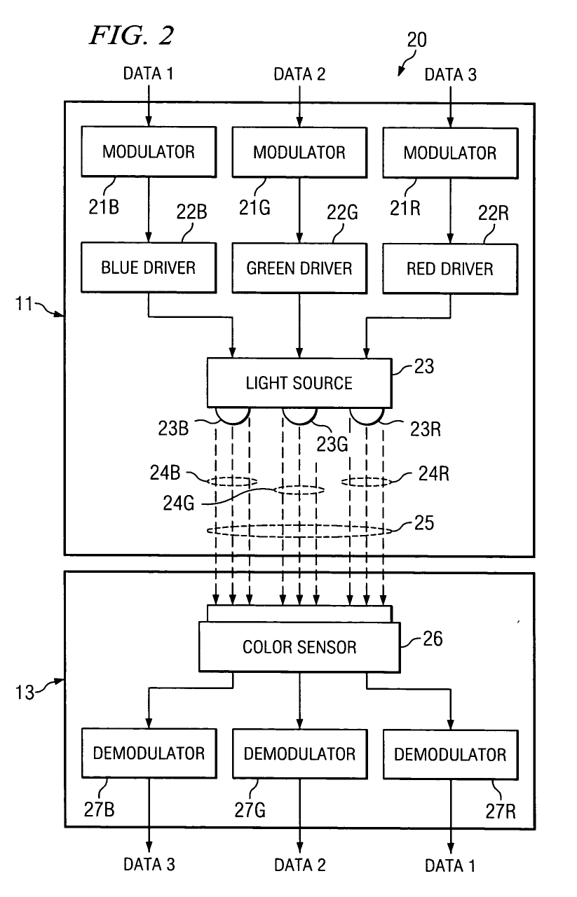

FIG. 2 shows one implementation 20 in which three data channels are utilized. Data on channel DATA 1 goes to modulator 21R, while data on channel DATA 2 goes to modulator 21G, and data on channel DATA 3 goes to modulator 21B. These three modulators are associated with red, green, and blue light sources respectively, which are the three light sources available in this implementation. Note that while three modulators are shown, a single modulator could be utilized, for example, in a time multiplexed manner, if desired. Also note that the modulators are preferably digital modulators.

The outputs of the modulators modulate the light of each driver independently such that red driver 22R is modulated by data on input DATA 1, green driver 22G is modulated by data on input DATA 2, while blue driver 22B is modulated by data on input DATA 3. The outputs of the drivers then drive the three light sources 23B, 23G and 23R of light source 23. Note that in the embodiment shown each light source 23B, 23G, 23R is shown as a single source, but in reality each source can be a plurality of individual light sources, such as LEDs, LCDs, etc.

Broken lines 24B represent the modulated light from light source 23B while broken lines 24G represent the modulated light from source 23G and likewise broken lines 24R represent the modulated light from light source 23R. This light is in the visual range and is detected, in one embodiment, by color sensor 26 which is a sensor utilizing filters.

The output of color sensor 26, which sensor could be on a color-by-color basis, or integrated for several colors, is separated with respect to the various light frequencies. Accordingly, blue modulated light is provided to demodulator 27B, green modulated light is provided to demodulator 27G, while red modulated light is provided to demodulator 27R. The outputs of these three demodulators then recover the data from input DATA 1, input DATA 2, input DATA 3. Note that device 13 can be a mobile device coming into proximity of light source 11 from time to time, or it can be stationary with respect to light source 11.

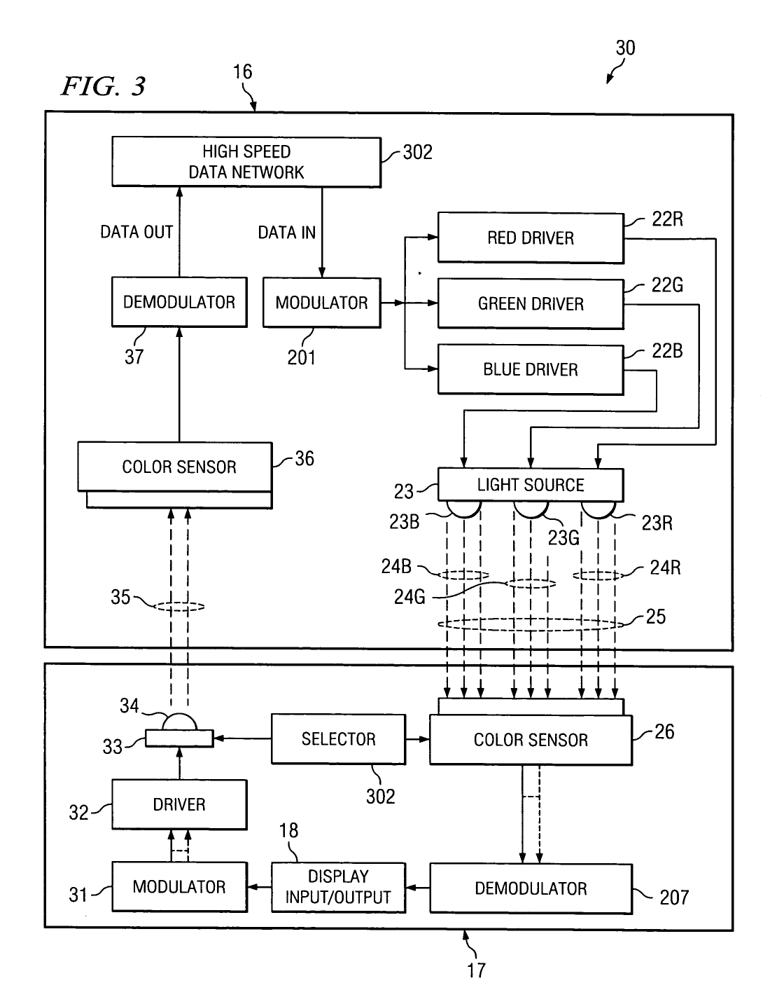

FIG. 3 shows system 30 which is one embodiment of a multi-directional system such that data coming in from high speed network 302 is provided to one or more of the blue, green, or red drivers 22B, 22G, or 22R, respectively. Note that in this embodiment, modulator 201 can be a single modulator or could be three modulators as shown in FIG. 2 and that any number of colors can be utilized. As discussed with respect to FIG. 2, color sensor 26 receives the modulated light in remote unit 17 and provides the individual outputs to demodulator 207. Note that if only one color was utilized then only one color would be provided to demodulator 207. However, in situations where there are multiple colors being utilized, all the modulated colors (or channels) can be provided to demodulator 207. If desired, a selector, such as selector 302, can be used to select or tune color sensor 26 to select which of the color(s) are provided to demodulator 207 (or to demodulators 27B, 27G, 27R in FIG. 2).

Assuming one channel is selected in demodulator, that channel is provided to display input/output 18 for communal (or private) display to a user. The user could then input information via input/output 18 which data then is provided to modulator 31 and LED driver 32. LED driver 32 then drives light source 33 having a specific color 34 which color is different from the colors currently being used for the direction from device 16 to device 17. These selected colors can be on a permanent bases, such that, for example, yellow is always used from device 17 to device 16, while red is always used from device 16 to device 17.

The system could also be set so that selector 302 determines which color is coming in the direction towards device 17 and then controls light source 33 so that a different color is used in the reverse direction. In any event, the color going from device 17 to device 16 is a different color than is used from device 16 to device 17 thereby allowing simultaneously transmitted bi-directional modulation. Color sensor 36 provides the proper color modulated light to modulator 37 which in turn provides the data from input/output 18 to high speed data network 302. Note that high speed data network 301 is only necessary if, in fact, the information is to go beyond device 16. In some situations, the information goes back and forth between device 16 and device 17 without need for delivery to any further destination.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A visual light communication system comprising:
at least one light source, said light source having a plurality of wavelengths in the visual spectrum;
at least one modulator for placing data independently onto each said wavelength;
at least one demodulator at one or more visual light receiving devices for recovering said data for each said wavelength; and
a plurality of color sensors for separating wavelengths coming to each said demodulator.

2. The system of claim 1 wherein certain of said wavelengths are reserved for data traveling in a first direction and certain of said wavelengths are reserved for light traveling in a second direction.

3. The system of claim 2 further comprising:
a selector for, at least in part, controlling the wavelength data is received on.

4. The system of claim 1 wherein said data modulation is ancillary to another function of said light source.

5. The system of claim 4 wherein said another function is to provide a visual display made up of a combination of said light source wavelengths.

6. The system of claim 1 further comprising:
means for selectively enabling certain of said color sensors.

7. The system of claim 1 wherein said at least one light source is selected from the list of:
LED, LCD.

8. The system of claim 7 wherein said wavelengths comprise at least, red, blue, green.

9. The system of claim 1 wherein said modulated data wavelengths travel outside of a bounded structure.

10. A method for visual light communication, said method comprising:
modulating data independently onto each wavelength of a multi-wavelength visual light source, and
demodulating said data for each said wavelength at one or more visual light receiving devices.

11. The method of claim 10 wherein certain of said wavelengths are reserved for data traveling in a first direction and certain of said wavelengths are reserved for light traveling in a second direction.

12. The method of claim 11 wherein said wavelength direction is selectable from time to time.

13. The method of claim 10 wherein said data modulation is ancillary to another function of said light source.

14. The method of claim 13 wherein said another function is to provide a visual display made up of a combination of said light source wavelengths.

15. The method of claim 10 further comprising:
prior to said demodulating separating said wavelengths using a separator.

16. The method of claim 10 wherein said light source is selected from the list of:
LED, LCD.

17. The method of claim 16 wherein said wavelengths comprise at least, red, blue, green.

18. The method of claim 10 wherein said modulated data wavelengths travel outside of a bounded structure.

19. A communication system comprising:
a visual display system for broadcast communicating information through the air to observers, said broadcast communication being light having wavelengths in the visual spectrum;
a modulator for introducing data onto at least some of said wavelengths, said data on anyone wavelength being independent from data on any other wavelength; and
a plurality of color sensors for separating wavelengths coming to said demodulator.

20. The system of claim 19 further comprising:
a demodulator remote from said display system for recovering data introduced onto at least one of said wavelengths.

21. The system of claim 20 wherein light waves of certain frequencies are reserved for particular directions.

22. The system of claim 20 further comprising:
color sensors for separating wavelengths for said demodulator.

23. A sign comprising:
a fixed structure comprising a plurality of different colored light sources, said light sources enabled to provide selectively controlled, visually discernable communal information;
means from individually modulating selected colors of said colored light, said modulation placing data on said colored light; and
means remote from said sign for demodulating received light so as to recover said modulated data from said light on a color of light basis.

24. The sign of claim 23 wherein said demodulating means comprises:
means for filtering received light into individual colors.

25. The sign of claim 23 wherein said demodulating means comprises:
means for controlling the selection of said color to be demodulated.

26. The sign of claim 23 further comprising:
means remote from said sign for modulating selected colors of visual light, said remote modulating means operable to place data on said visual light; and
means of said sign for demodulating light received from said remote modulator location to recover said modulated data.

27. The sign of claim 26 wherein the color of said modulated visual light from said remote location is different from any color light modulated at said sign.
